(19) United States
(12) Patent Application Publication
(10) Pub. No.: US 2025/0380234 A1
(43) Pub. Date: Dec. 11, 2025

(54) REGISTRATION ENHANCEMENT FOR MULTI-ACCESS

(71) Applicant: Nokia Technologies Oy, Espoo (FI)

(72) Inventors: Jing PING, Chengdu (CN); Ranganathan MAVUREDDI DHANASEKARAN, Munich (DE); Suresh P NAIR, Estero, FL (US)

(21) Appl. No.: 19/104,014

(22) PCT Filed: Aug. 16, 2022
(86) PCT No.: PCT/CN2022/112640

§ 371 Date: Feb. 14, 2025

(51) Int. Cl. H04W 60/00; H04W 12/06; H04W 48/16

(52) U.S. Cl. CPC H04W 60/005; H04W 12/06; H04W 48/16

(57) ABSTRACT

Embodiments of the present disclosure relate to registration enhancements for multi-access. A terminal device is provided comprising at least one processor and at least one memory storing instructions. The instructions, when executed by the at least one processor, cause the terminal device at least to: initiate a first registration procedure with a first network device of a first PLMN, and based on determining that the first registration procedure is completed, initiate a second registration procedure with a second network device of a second PLMN. As such, registration for multi-access is enhanced.

### TECHNICAL FIELD

Various example embodiments relate to the field of communication, and in particular, to devices, methods, apparatuses and computer readable storage media for registration enhancements for multi-access.

### BACKGROUND

Registrations over multiple access technologies may occur in new communication systems, which may also involve Network Slice Selection Authentication and Authorization (NSSAA) procedures. Registration enhancements for multi-access need to be studied.

### SUMMARY

In general, example embodiments of the present disclosure provide devices, methods, apparatuses and computer readable storage media for registration (e.g., NSSAA) enhancements for multi-access.

In a first aspect, there is provided a terminal device. The terminal device comprises at least one processor, and at least one memory storing instructions. The instructions, when executed by the at least one processor, cause the terminal device at least to: initiate a first registration procedure with a first network device of a first public land mobile network, PLMN; and based on determining that the first registration procedure is completed, initiate a second registration procedure with a second network device of a second PLMN.

In a second aspect, there is provided a terminal device. The terminal device comprises at least one processor, and at least one memory storing instructions. The instructions, when executed by the at least one processor, cause the terminal device at least to: receive, from a second network device, a request message for extensible authentication protocol identity, EAP ID, for a second EAP authentication, the request message comprising a single network slice selection assistance information, S-NSSAI; determine, based at least partly on the request message, that a first EAP authentication for the S-NSSAI is ongoing; and transmit, to the second network device based on the determination, a response message, the response message comprising an indication indicating that the first EAP authentication is ongoing.

In a third aspect, there is provided a second network device. The second network device comprises at least one processor, and at least one memory storing instructions. The instructions, when executed by the at least one processor, cause the second network device at least to: transmit, to a terminal network device, a request message for extensible authentication protocol identity, EAP ID, for a second EAP authentication, the request message comprising a single network slice selection assistance information, S-NSSAI; and receive, from the terminal network device, a response message, the response message comprising an indication indicating that a first EAP authentication for the S-NSSAI is ongoing.

In a fourth aspect, there is provided a second network device. The second network device comprises at least one processor, and at least one memory storing instructions. The instructions, when executed by the at least one processor, cause the second network device at least to: transmit, to a third network device, an authentication request message for a second network slice specific authentication and authorization, NSSAA, of a terminal device, the authentication request message comprising at least a single network slice selection assistance information, S-NSSAI, and a generic public subscription identifier, GPSI; and receive, from the third network device, an authentication rejection message, the first authentication rejection message comprising at least the S-NSSAI and an indication indicating that a first NSSAA for the S-NSSAI is ongoing.

In a fifth aspect, there is provided a third network device. The third network device comprises at least one processor, and at least one memory storing instructions. The instructions, when executed by the at least one processor, cause the third network device at least to: receive, from a second network device, an authentication request message for a second network slice specific authentication and authorization, NSSAA, of a terminal device, the authentication request message comprising at least a single network slice selection assistance information, S-NSSAI, and a generic public subscription identifier, GPSI; and determine, based at least partly on the authentication request message, that a first NSSAA of the terminal device for the S-NSSAI is ongoing, the first NSSAA being associated with a first network device.

In a sixth aspect, there is provided a third network device. The third network device comprises at least one processor, and at least one memory storing instructions. The instructions, when executed by the at least one processor, cause the third network device at least to: receive, from a second network device, an authentication request message for a second network slice specific authentication and authorization, NSSAA of a terminal device, the authentication request message comprising at least a single network slice selection assistance information, S-NSSAI, a first access and mobility management function, AMF, information of the second network device, and a generic public subscription identifier, GPSI; and transmit, to a fourth network device, a first authentication protocol message, the first authentication protocol message comprising at least the S-NSSAI, the first AMF information, and the GPSI.

In a seventh aspect, there is provided a fourth network device. The fourth network device comprises at least one processor, and at least one memory storing instructions. The instructions, when executed by the at least one processor, cause the fourth network device at least to: receive, from a third network device, a first authentication protocol message for a second extensible authentication protocol, EAP, authentication of a terminal device, the first authentication protocol message comprising at least a single network slice selection assistance information, S-NSSAI, a first access and mobility management function, AMF, information of the second network device, and a generic public subscription identifier, GPSI; determine, based at least partly on the first authentication protocol message, that a first EAP authentication of the terminal device for the S-NSSAI is ongoing; and transmit, to the third network device, a second authentication protocol message, the second authentication protocol message comprising at least the S-NSSAI, the first AMF information, GPSI, and an indication indicating the first EAP authentication is ongoing.

In an eighth aspect, there is provided a method. The method comprises initiating, at a terminal device, a first registration procedure with a first network device of a first public land mobile network, PLMN; and based on determining that the first registration procedure is completed, initiating a second registration procedure with a second network device of a second PLMN.

In a ninth aspect, there is provided a method. The method comprises receiving, at a terminal device and from a second network device, a request message for extensible authentication protocol identity, EAP ID, for a second EAP authentication, the request message comprising a single network slice selection assistance information, S-NSSAI; determining, based at least partly on the request message, that a first EAP authentication for the S-NSSAI is ongoing; and transmitting, to the second network device based on the determination, a response message, the second message comprising an indication indicating that the first EAP authentication is ongoing.

In a tenth aspect, there is provided a method. The method comprises transmitting, at a second network device and to a terminal network device, a request message for extensible authentication protocol identity, EAP ID, for a second EAP authentication, the request message comprising a single network slice selection assistance information, S-NSSAI; and receiving, from the terminal network device, a response message, the response message comprising an indication indicating that a first EAP authentication for the S-NSSAI is ongoing.

In a eleventh aspect, there is provided a method. The method comprises transmitting, at a second network device and to a third network device, an authentication request message for a second network slice specific authentication and authorization, NSSAA, of a terminal device, the authentication request message comprising at least a single network slice selection assistance information, S-NSSAI, and a generic public subscription identifier, GPSI; and receiving, from the third network device, an authentication rejection message, the first authentication rejection message comprising at least the S-NSSAI and an indication indicating that a first NSSAA for the S-NSSAI is ongoing.

In a twelfth aspect, there is provided a method. The method comprises receiving, at a third network device and from a second network device, an authentication request message for a second network slice specific authentication and authorization, NSSAA, of a terminal device, the authentication request message comprising at least a single network slice selection assistance information, S-NSSAI, and a generic public subscription identifier, GPSI; and determining, based at least partly on the authentication request message, that a first NSSAA of the terminal device for the S-NSSAI is ongoing, the first NSSAA being associated with a first network device.

In a thirteenth aspect, there is provided a method. The method comprises receiving, at a third network device and from a second network device, an authentication request message for a second network slice specific authentication and authorization, NSSAA of a terminal device, the authentication request message comprising at least a single network slice selection assistance information, S-NSSAI, a first access and mobility management function, AMF, information of the second network device, and a generic public subscription identifier, GPSI; and transmitting, to a fourth network device, a first authentication protocol message, the first authentication protocol message comprising at least the S-NSSAI, the first AMF information, and the GPSI.

In a fourteenth aspect, there is provided a method. The method comprises receiving, at a fourth network device and from a third network device, a first authentication protocol message for a second extensible authentication protocol, EAP, authentication of a terminal device, the first authentication protocol message comprising at least a single network slice selection assistance information, S-NSSAI, a first access and mobility management function, AMF, information of the second network device, and a generic public subscription identifier, GPSI; determining, based at least partly on the first authentication protocol message, that a first EAP authentication of the terminal device for the S-NSSAI is ongoing; and transmitting, to the third network device, a second authentication protocol message, the second authentication protocol message comprising at least the S-NSSAI, the first AMF information, GPSI, and an indication indicating the first EAP authentication is ongoing.

In a fifteenth aspect, there is provided an apparatus. The apparatus comprises means for performing the method according to the eighth, ninth, tenth, eleventh, twelfth, thirteenth or fourteenth aspect.

In a sixteenth aspect, there is provided a computer readable medium comprising program instructions. The instructions, when executed by an apparatus, cause the apparatus to perform the method according to the eighth, ninth, tenth, eleventh, twelfth, thirteenth or fourteenth aspect.

In a seventeenth aspect, there is provided a computer program comprising instructions, which, when executed by an apparatus, cause the apparatus at least to perform the method according to the eighth, ninth, tenth, eleventh, twelfth, thirteenth or fourteenth aspect.

In a eighteenth aspect, there is provided a device. The device comprises circuitries for performing the method according to the eighth, ninth, tenth, eleventh, twelfth, thirteenth or fourteenth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1A illustrates an example communication system in which implementations of the present disclosure can be implemented;

FIG. 1B illustrates an example NSSAA procedure, with which some embodiments of the present disclosure can be implemented together;

FIG. 1C illustrates an example diagram of UE registering with two PLMNs or registering with a PLMN and a standalone non-public network (SNPN), with which some embodiments of the present disclosure can be implemented together;

FIG. 1D illustrates an example diagram of UE registering with two PLMNs or registering with two SNPNs, with which some embodiments of the present disclosure can be implemented together;

FIG. 1E illustrates an example diagram of UE registering twice in the same network, with which some embodiments of the present disclosure can be implemented together;

FIG. 2A illustrates an example flowchart showing an example process in accordance with some embodiments of the present disclosure;

FIG. 2B illustrates an example signaling chart showing an example process in accordance with some embodiments of the present disclosure;

FIG. 2C illustrates another example signaling chart showing an example process in accordance with some embodiments of the present disclosure;

FIG. 2D illustrates another example signaling chart showing an example process in accordance with some embodiments of the present disclosure;

FIG. 3 illustrates an example signaling chart showing an example process of keeping single NSSAA session with controlling registration procedure, in accordance with some embodiments of the present disclosure;

FIG. 4 illustrates an example signaling chart showing an example process of single NSSAA session controlled by UE, in accordance with some embodiments of the present disclosure;

FIG. 5 illustrates an example signaling chart showing an example process of single NSSAA session controlled by NSSAAF, in accordance with some embodiments of the present disclosure;

FIG. 6 illustrates an example signaling chart showing an example process of single NSSAA session controlled by NSSAAF for re-authentication, in accordance with some embodiments of the present disclosure;

FIG. 7 illustrates an example signaling chart showing an example process of single NSSAA session controlled by AAA-S, in accordance with some embodiments of the present disclosure;

FIG. 8 illustrates a flowchart of an example method implemented at a terminal device in accordance with some embodiments of the present disclosure;

FIG. 9 illustrates a flowchart of an example method implemented at a second network device in accordance with some embodiments of the present disclosure;

FIG. 10 illustrates a flowchart of another example method implemented at a second network device in accordance with some embodiments of the present disclosure;

FIG. 11 illustrates a flowchart of an example method implemented at a third network device in accordance with some embodiments of the present disclosure;

FIG. 12 illustrates a flowchart of another example method implemented at a third network device in accordance with some embodiments of the present disclosure;

FIG. 13 illustrates a flowchart of an example method implemented at a fourth network device in accordance with some embodiments of the present disclosure;

FIG. 14 shows a simplified block diagram of a device that is suitable for implementing example embodiments of the present disclosure; and

FIG. 15 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communication between a terminal device and a network device in the communication network may be performed according to any suitable generation communication protocols, including, but not limited to, the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communication, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As mentioned above, registrations over multiple access technologies may occur in new communication systems. This scenario may involve several procedures, such as the possible simultaneous UE registration over 3GPP access and non 3GPP access and the subsequent NSSAA. Depending on the network selection of the UE, the registration over the two access types may happen in one public land mobile network (PLMN) or in two different PLMNs.

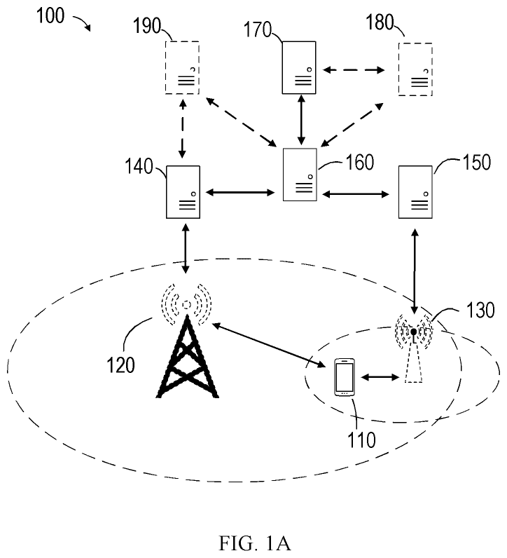

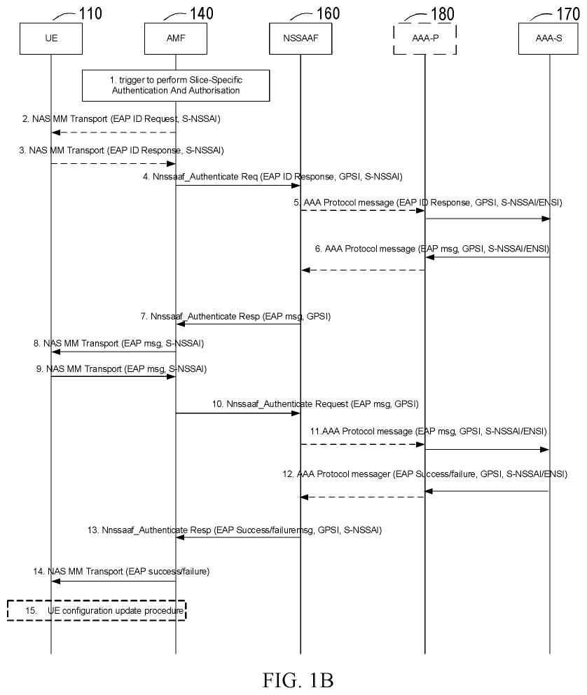

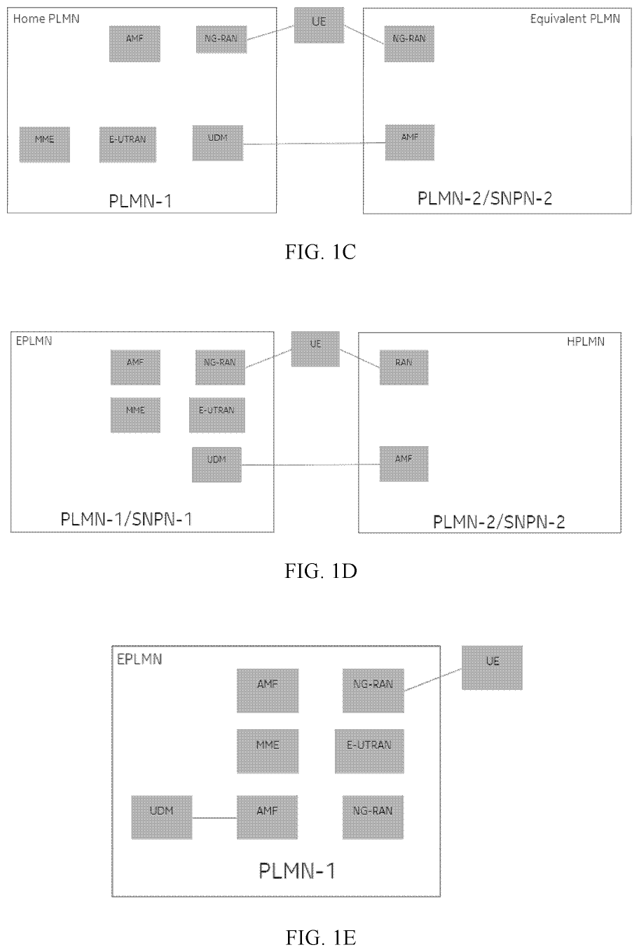

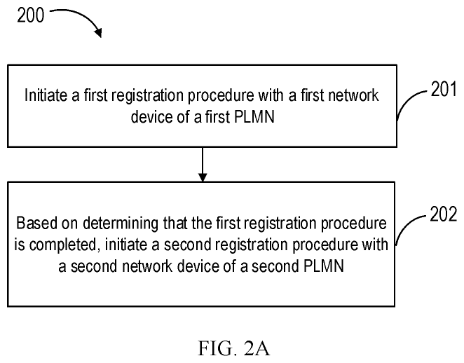

Principle and implementations of the present disclosure will be described in detail below with reference to FIGS. 1A to 16. FIG. 1A shows an example communication system 100 in which embodiments of the present disclosure can be implemented. The system 100 may include a terminal device (e.g., a UE) 110, a first access point (e.g., a gNB) 120 and a second access point (e.g., a WLAN device) 130. The terminal device 110 may access network over the first access point 120 and/or the second access point 130. The first access point 120 interacts with a first network device (e.g., a first AMF, AMF #1) 140, and the second access point 130 interacts with a second network device (e.g., a second AMF, AMF #2) 150. As an example, the first access point 120 and the first network device 140 may belong to a first PLMN (PLMN #1), and the second access point 130 and the second network device 150 may belong to a second PLMN (PLMN #2). Note that the first access point 120, the first network device 140, the second access point 130 and the second network device 150 may also belong to the same PLMN.

The AMF #1 140 and AMF #2 150 communicate with a third network device (e.g., a network slice specific authentication and authorization function, NSSAAF) 160. The NSSAAF 160 interacts directly with a fourth network device (e.g., an authentication, authorization, and accounting server, AAA-S) 170 or interacts indirectly with the AAA-S 170 via an AAA-proxy (AAA-P) 180. In some embodiments, the AAA-P 180 may also be referred to as a fourth network device. The system 100 may further include an unified data management (UDM) 190, which may communicate with the NSSAAF 160, AMF #1 140 and/or AMF #2 150. It is to be understood that the number of network devices and terminal devices and the specific interactions between them are only for the purpose of illustration without suggesting any limitations. The system 100 may include any suitable number of network devices and terminal devices adapted for implementing embodiments of the present disclosure.

Communications in the system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Introduce NSSAA general procedure. FIG. 1B illustrates an example NSSAA procedure, with which some embodiments of the present disclosure can be implemented together. As shown in FIG. 1B, NSSAA is triggered by AMF 140 for an S-NSSAI during registration procedure, if required. The UE 110, AMF 140, NSSAAF 160, AAA-S 170 and AAA-P 180 are entities involved in the procedure, which should maintain following information to complete procedure with interaction. Specifically, UE maps between EAP id and (SUPI/GPSI+S-NSSAI), AAA-S maps between EAP Id and (GPSI+S-NSSAI), NSSAAF maps between AMF id and (GPSI+S-NSSAI) and maps between S-NSSAI and AAA server, AMF maps between SUPI and GPSI, and AMF maps between SUPI and GPSI. SUPI is an abbreviation of subscription permanent identifier. In FIG. 1B, EAP Id response and EAP msg are encapsulated in EAP package which are transparently passed through 3GPP network, and they're invisible to either AMF or NSSAAF. EAP Id is used to identify authentication session between UE and AAA. (GPSI+S-NSSAI) is used to identify NSSAA session between AAA, NSSAA and AMF.

Regarding NSSAA enhancements for multi-access, introduce some potential cases below. There may be a case that NSSAA in two simultaneous registrations of single PLMN may happen. Similar to primary authentication in two registrations scenario, a single AMF is responsible for both 3agpp and non-3gpp registration, therefore the AMF could control the sequence of NSSAA, e.g., the AMF could decide not to trigger NSSAA procedure of a S-NSSAI for the second access type if the NSSAA procedure of the S-NSSAI for the first access type is successful, or trigger NSSAA of the S-NSSAI for the second access type only after the NSSAA procedure of the S-NSSAI for the first access type was completed.

There may be a case that NSSAA procedure in two registrations of two PLMNs. Theoretically, the AMF of one access type in PLMN-1 could trigger NSSAA procedure independently even if there's one NSSAA procedure ongoing for another access type in PLMN-2. The UE, NSSAAF and AAA-S may be capable to decide whether accept the second NSSAA of an S-NSSAI while there's another NSSAA procedure of the S-NSSAI is ongoing. According to information listed in slide 2, only one EAP authentication session is supported which is identified by EAP Id or GPSI+S-NSSAI. Especially, it requires “The UE shall not attempt re-registration with the S-NSSAIs included in the list of Pending NSSAIs until the Network Slice-Specific Authentication and Authorization procedure has been completed, regardless of the Access Type.”

Multiple registrations have been studied in Rel-18 and previous releases of TS 33.501. This study involves multiple registrations in different PLMNs. The UE shall independently maintain and use two different 5G security contexts, one per serving PLMN's network. Each security context shall be established separately via a successful primary authentication procedure with the Home PLMN. The ME shall store the two different 5G security contexts on the USIM if the USIM supports the 5G parameters storage. If the USIM does not support the 5G parameters storage, then the ME shall store the two different 5G security contexts in the ME non-volatile memory. Both of the two different 5G security contexts are current 5G security context. The latest KAUSE result of the successful completion of the latest primary authentication shall be used by the UE and the HN regardless over which access network type (3GPP or non-3GPP) it was generated. The HN shall keep the latest KAUsE generated during successful authentication over a given access even if the UE is deregistered from that access, but the UE is registered via another access.

This study also involves multiple active non-access stratum (NAS) connections with different PLMNs. TS 23.501 has a scenario when the UE is registered to a visited PLMN (VPLMN)'s serving network via 3GPP access and to another VPLMN's or home PLMN (HPLMN)'s serving network via non-3GPP access at the same time. When the UE is registered in one PLMN's serving network over a certain type of access (e.g. 3GPP) and is registered to another PLMN's serving network over another type of access (e.g. non-3GPP), then the UE has two active NAS connections with different AMF's in different PLMNs. As described in clause 6.3.2.1 of TS 33.501, the UE shall independently maintain and use two different 5G security contexts, one per PLMN serving network. The 5G security context maintained by the UE shall contain the full set of 5G parameters, including NAS context parameters for 3GPP and non-3GPP access types per PLMN. In case of connection to two different PLMNs, it is necessary to maintain a complete 5G NAS security context for each PLMN independently, each with all associated parameters (such as two pairs of NAS COUNTs, i.e. one pair for 3GPP access and one pair for non-3GPP access). Each security context shall be established separately via a successful primary authentication procedure with the Home PLMN. All the NAS and AS security mechanisms defined for single registration mode are applicable independently on each access using the corresponding 5G security context. The UE belongs to a single HPLMN.

About rules related to parallel NAS connections, the UE shall not initiate a NAS registration over a second NAS connection to an AMF of the same network before primary authentication on the first NAS connection is complete.

Multiple registrations have been studied in Rel-19 from SAI approved study. In the new Rel-19 SAI study S1-221231 “Study on Upper layer traffic steering, switching and split over dual 3GPP access”, the objectives include: Study additional use cases and potential service requirements that could benefit from 5GS support of upper layer steering, split and switching of UE's traffic (e.g. pertaining to the same data session) across two 3GPP access links, assuming only single subscription to a PLMN, including the following scenarios:
Single PLMN, PLMN plus (standalone) non-public network (NPN), two PLMNs;
Same or different 3GPP RATs (NR or non-terrestrial network (NTN), plus one of NR, NTN or LTE).

NTN refers to NR-based satellite access, including different orbits (e.g., GEO/MEO/LEO). For the PLMN plus PLMN/NPN scenarios, the two networks can be managed by the same operator or by different operators (assumed to have a business agreement among them).

FIGS. 1C-1E illustrate example diagrams of multiple UE registrations respectively. For example, UE may register with two PLMNs (e.g., PLMN-1 and PLMN-2 in FIGS. 1C and 1D), register with a PLMN and a SNPN (e.g., PLMN-1 and SNPN-2 in FIG. 1C), or register twice in the same network (e.g., PLMN-1 in FIG. 1E).

NSSAA enhancements for multi-access may involve AMF info, which is shown in Table 1 below.

TABLE 1
Definition of type AmfInfo

| Attribute name | Data type | P | Cardinality | Description |
|---|---|---|---|---|
| amfRegionId | AmfRegionId | M | 1 | AMF region identifier |
| amfSetId | AmfSetId | M | 1 | AMF set identifier. |
| guamiList | array(Guami) | M | 1 . . . N | List of supported GUAMIs |
| taiList | array(Tai) | O | 1 . . . N | The list of TAIs the AMF can serve. It may |
| | | | | contain one or more non-3GPP access TAIs. |
| | | | | The absence of this attribute and the |
| | | | | taiRangeList attribute indicate that the AMF can |
| | | | | be selected for any TAI in the serving network. |
| taiRangeList | array(TaiRange) | O | 1 . . . N | The range of TAIs the AMF can serve. It may |
| | | | | contain non-3GPP access TAIs. The absence |
| | | | | of this attribute and the taiList attribute indicate |
| | | | | that the AMF can be selected for any TAI in the |
| | | | | serving network. |
| backupInfoAmfFailure | array(Guami) | O | 1 . . . N | List of GUAMIs for which the AMF acts as a |
| | | | | backup for AMF failure |
| backupInfoAmfRemoval | array(Guami) | O | 1 . . . N | List of GUAMIs for which the AMF acts as a |
| | | | | backup for planned AMF removal |
| n2InterfaceAmfInfo | N2InterfaceAmfInfo | O | 0 . . . 1 | N2 interface information of the AMF. This |
| | | | | information needs not be sent in NF Discovery |
| | | | | responses. It may be used by the NRF to |
| | | | | update the DNS for AMF discovery by the 5G |
| | | | | Access Network. The procedures for updating |
| | | | | the DNS are out of scope of this specification. |

According to the contents described above, multiple simultaneous NSSAA may get triggered by AMFs of different PLMNs because of the following reasons. For example, UE may initiate a registration to an AMF of the second network, which may trigger a NSSAA on an S-NSSAI, before NSSAA of the S-NSSAI triggered in the first network has not completed. This scenario is currently not clearly specified in the existing technical specifications, but if this happens the EAP layer in the UE will not be able to handle parallel EAP authentication with the same EAP server and EAP id. So how to handle this scenario need to be spelt out clearly in the specifications. From the network side, the AAA-S which is authenticating the UE for the network slice in the NSSAA procedure, may initiate re-authentication and reauthorization of the UE, technically any time after the authentication for any reason. If this happens the behavior of NSSAF which receives the re-authentication request is not clearly defined, the NSSAAF may trigger either or both AMFs to initiate new NSSAA procedure(s). This may lead to raising conditions in the UE involving AMF in two networks.

There are some potential issues of the mentioned gap in the currently existing solutions. For example, there's no clear requirement or solution to address potential race condition issue regarding sequence number (SQN) value caused by multi-registration in multiple (e.g., two) PLMNs during primary authentication. There's further no clear requirement or solution on UE regarding how to proceed multiple EAP ID requests from different PLMNs for a same S-NSSAI. There's further no clear requirement or solution on NSSAAF regarding how to proceed EAP messages of same (GPSI+S-NSSAI) from multiple AMFs of different PLMNs and distribute the EAP messages from AAA-S to AMFs. There's further no clear requirement or solution on AAA-S regarding how to proceed EAP ID response of same (GPSI+S-NSSAI) if there's ongoing EAP authentication session, in case EAP ID is same or different.

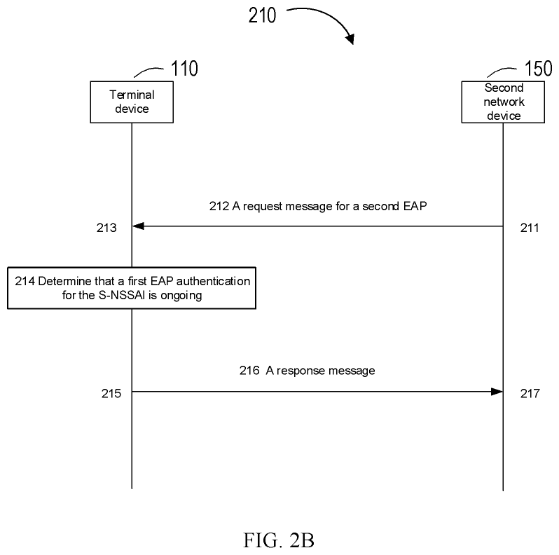

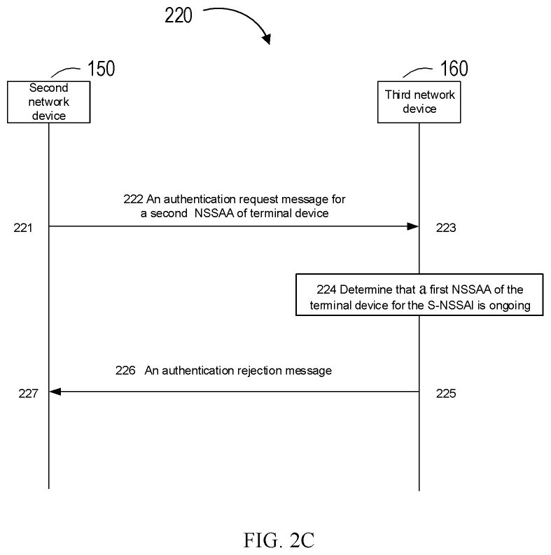

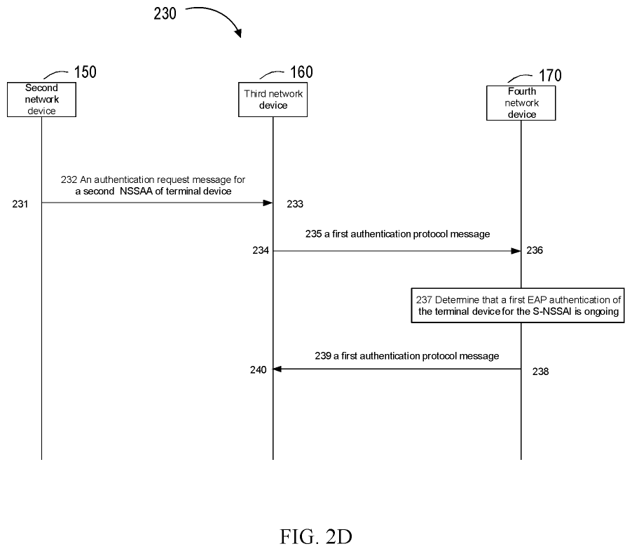

According to embodiments of the present disclosure, there is providing NSSAA enhancements for multi-access. Details of the registration enhancements for multi-access will be described with reference to FIGS. 2A-7 below.

FIG. 2A illustrates an example flowchart showing an example process 200 in accordance with some embodiments of the present disclosure. For the purpose of discussion, the process 200 will be described with reference to FIG. 1A. The process 200 may involve the terminal device (e.g., a UE) 110.

At block 201, the terminal device 110 initiates a first registration procedure with a first network device (e.g., AMF #1 140) of a first PLMN. At block 202, based on determining that the first registration procedure is completed, the terminal device 110 initiates a second registration procedure with a second network device (e.g., AMF #2 150) of a second PLMN.

In some embodiments, the terminal device 110 may further determine a first pending set of NSSAI associated with the first registration procedure, based on a registration accept message of the first registration procedure from the first network device. Moreover, the terminal device 110 may further map the first pending set of NSSAI to a second pending set of NSSAI associated with the second registration procedure. In some embodiments, the terminal device 110 may further exclude a set of S-NSSAI of the second pending set of NSSAI from a requested set of NSSAI associated with the second registration procedure.

FIG. 2B illustrates an example signaling chart showing an example process 210 in accordance with some embodiments of the present disclosure. For the purpose of discussion, the process 210 will be described with reference to FIG. 1A. The process 210 may involve the terminal device (e.g., a UE) 110 and the second network device (e.g., AMF #2) 150.

As shown in FIG. 2B, the second network device 150 transmits 211, to the terminal network device, a request message 212 for EAP ID for a second EAP authentication. The request message comprises an S-NSSAI. After receiving 213 the request message 212 for EAP ID for the second EAP authentication, terminal device 110 determines 214, based at least partly on the request message, that a first EAP authentication for the S-NSSAI is ongoing. Then, terminal device 110 transmits 215, to the second network device based on the determination, a response message 216. The response message comprises an indication indicating that the first EAP authentication is ongoing. The second network device 150 receives 217 the response message.

FIG. 2C illustrates another example signaling chart showing an example process 220 in accordance with some embodiments of the present disclosure. For the purpose of discussion, the process 220 will be described with reference to FIG. 1A. The process 220 may involve the second network device (e.g., AMF #2) 150 and the third network device (e.g., NSSAAF) 160.

As shown in FIG. 2C, the second network device 150 transmits 221, to the third network device, an authentication request message 222 for a second NSSAA of a terminal device. The authentication request message comprises at least an S-NSSAI and a GPSI. After receiving 223 the authentication request message 222, the third network device 160 determines 224, based at least partly on the authentication request message, that a first NSSAA of the terminal device for the S-NSSAI is ongoing. The first NSSAA is associated with a first network device.

Then, the third network device 160 may transmit 225, to the second network device based on the determination, an authentication rejection message 226. The authentication rejection message comprises at least the S-NSSAI, the GPSI, and an indication indicating that the first NSSAA is ongoing. The second network device 150 receives 227 the authentication rejection message 226.

FIG. 2D illustrates another example signaling chart showing an example process 230 in accordance with some embodiments of the present disclosure. For the purpose of discussion, the process 220 will be described with reference to FIG. 1A. The process 220 may involve the second network device (e.g., AMF #2) 150, the third network device (e.g., NSSAAF) 160, and the fourth network device (e.g., AAA-S) 170.

As shown in FIG. 2D, the second network device 150 transmits 231, to the third network device, an authentication request message 232 for a second NSSAA of a terminal device. The authentication request message comprises at least an S-NSSAI, first AMF information of the second network device, and a GPSI. After receiving 233 the authentication request message 232, the third network device 160 transmits 234, to a fourth network device, a first authentication protocol message. The authentication protocol message comprises at least the S-NSSAI, the first AMF information, and the GPSI.

After receiving 236 the first authentication protocol message, the fourth network device 170 determines 237, based at least partly on the first authentication protocol message, that a first EAP authentication of the terminal device for the S-NSSAI is ongoing. Then, the fourth network device 170 transmits 238, to the third network device, a second authentication protocol message 239. The second authentication protocol message comprises at least the S-NSSAI, the first AMF information, the GPSI, and an indication indicating the first EAP authentication is ongoing. The third network device 160 receives 240 the second authentication protocol message 239.

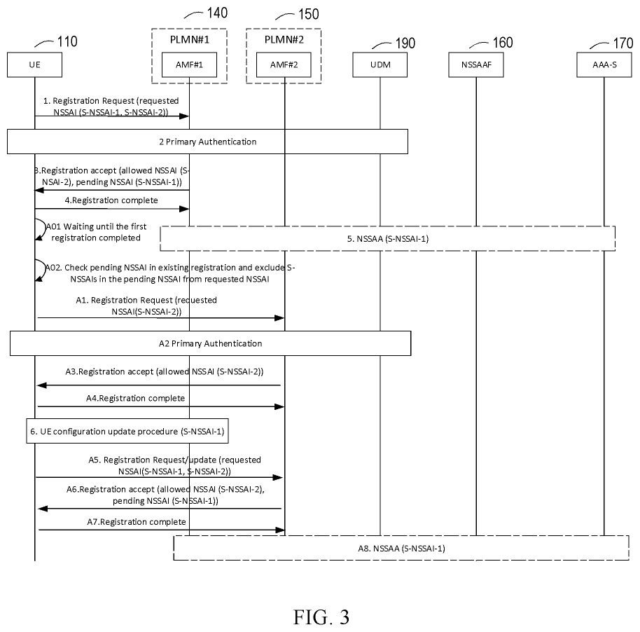

FIG. 3 illustrates an example signaling chart showing an example process of keeping single NSSAA session with controlling registration procedure, in accordance with some embodiments of the present disclosure. For the purpose of discussion, the process will be described with reference to FIG. 1A. The process may involve the UE 110, the AMF #1 140, the AMF #2 150, the UDM 190, the NSSAAF 160 and the AAA-S 170.

In the case, if the UE 110 is performing registration over one access and intends to perform registration over the other access in the different PLMN, the UE 110 shall not initiate the registration over the other access until the Registration procedure, including primary authentication, over first access is completed. Moreover, the UE 110 shall not attempt re-registration with the S-NSSAIs included in the list of Pending NSSAI of registration accept over first access until the Network Slice-Specific Authentication and Authorization procedure of the first access has been completed.

As shown in FIG. 3, the following procedures may be performed. 1. The UE 110 registered to the AMF #1 140 of the first PLMN (e.g., for 3gpp access) with S-NSSAI-1 and S-NSSAI-2 in the requested NSSAI. 2. The AMF #1 140 triggers primary authentication for the UE 110. 3-4. After primary authentication and authorization, the AMF #1 140 sends registration accept to the UE 110. As S-NSSAI-1 is subjected for NSSAA, the S-NSSAI-1 is put into pending NSSAI. The UE 110 sends registration complete message back to network.

In parallel with procedures 3 and 4, the AMF #1 140 triggers NSSAA procedure for S-NSSAI-1. At A01-A02, the UE 110 will register to another PLMN (e.g., for non-3gpp access). After received registration accept for the first registration, the UE 110 checks the pending NSSAI, map S-NSSAIs of the pending NSSAI for the first PLMN to S-NSSAIs for the second PLMN based on Serving PLMN S-NSSAIs to HPLMN S-NSSAIs mappings of the PLMN(s), and excludes the mapped pending S-NSSAIs for the second PLMN from requested NSSAI of the second registration. Then at A1, after completed the first registration, the UE 110 initiates another registration to the AMF #2 150 of the second PLMN (e.g., for non-3gpp access). It may include only S-NSSAI-2 in the requested NSSAI as S-NSSAI-1 is in the pending list of the first registration.

At A2, another primary authentication is triggered for the second access. Then, at A3-A4, after primary authentication and authorization, the AMF #2 150 sends registration accept to the UE 110 with S-NSSAI-2 in the allowed NSSAI. The UE 110 sends registration completion back to network.

After NSSAA for the first access, at 6, the AMF #1 140 may trigger to the UE 110 configuration update, and update S-NSSAI-1 from pending S-NSSAI to allowed S-NSSAI. Then, at A5, the UE 110 may send registration request/update for non-3gpp access with updated requested NSSAI which including S-NSSAI-1. After authorization, at A6-A7, the AMF #2 150 sends registration accept to the UE 110. As S-NSSAI-1 is subjected for NSSAA, the S-NSSAI-1 is put into pending NSSAI. The UE 110 sends registration completion back to network. At A8, The AMF #2 150 triggers NSSAA procedure for S-NSSAI-1.

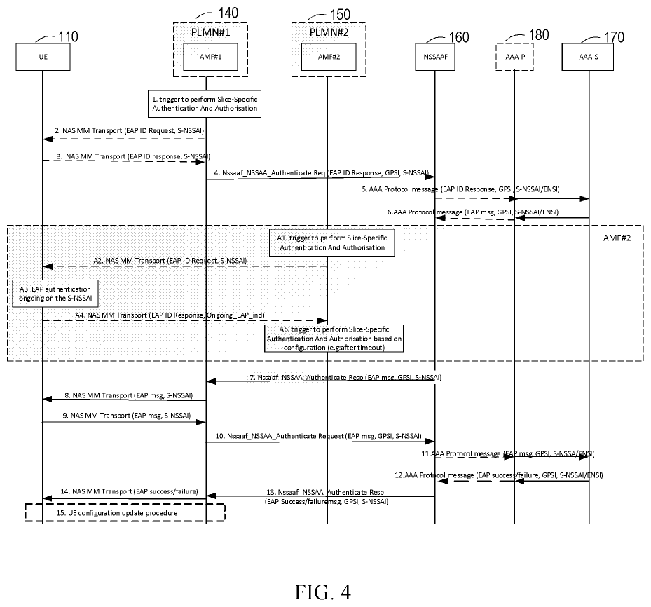

FIG. 4 illustrates an example signaling chart showing an example process of single NSSAA session controlled by UE, in accordance with some embodiments of the present disclosure. For the purpose of discussion, the process will be described with reference to FIG. 1A. The process may involve the UE 110, the AMF #1 140, the AMF #2 150, the NSSAAF 160, the AAA-P 180 and the AAA-S 170. In this case, the UE drops the EAP ID request (or answer negatively) for the same S-NSSAI from AMF #2 of the second PLMN if there's ongoing EAP authentication session on the S-NSSAI, or UE responds with indication such as to try later. AMF #2 of the second PLMN may send EAP ID request again later, and try several times based on configuration/policies.

As shown in FIG. 4, the following procedures may be performed. 1. For S-NSSAIs that are requiring NSSAA, based on change of subscription information, or triggered by the AAA-S, the AMF #1 may trigger the start of the NSSAA procedure. 2. The AMF #1 may request the UE User ID for EAP authentication (EAP ID) for the S-NSSAI in a NAS MM Transport message including the S-NSSAI. 3. The UE provides the EAP ID for the S-NSSAI alongside the S-NSSAI in an NAS MM Transport message towards the AMF #1. 4. The AMF #1 sends the EAP ID response to the NSSAAF which provides interface with the AAA. 5. The NSSAAF forwards the EAP ID Response message to directly/indirectly to the AAA-S. The AAA-S uses the EAP-ID and S-NSSAI to identify for which UE and slice authorization is requested.

At A1, the AMF #2 decides to trigger the slice specific Authentication and authorization towards the UE, at A2, the AMF #2 may request the UE User ID for EAP authentication (EAP ID) for the S-NSSAI in a NAS MM Transport message including the S-NSSAI. Then, at A3, the UE checks the S-NSSAI and identifies on-going EAP authentication for the same S-NSSAI. AT A4, the UE responds with failure cause in EAP ID response, as 5GMM cause as “ongoing_EAP_IND” to the AMF #2. Similar to AMF monitoring of EAP-Success behavior, UE NAS layer will monitor for the EAP-success for the first EAP authentication scenario, if it is not receives the EAP-success, NAS will respond with 5GMM failure cause as “ongoing_EAP_IND”.

AT A5, AMF #2 starts the timer based on the operator configuration and after the time out the AMF #2 re-triggers the Slice specific authentication and authorization procedure. If the retry attempts are exhausted, the AMF #2 stops the slice-specific authentication and authorization procedure. If the AMF #2 stops the slice-specific authentication and authorization procedure (i.e. after exhausting the retry attempts or when the UE becomes unreachable), the AMF shall keep the “status” attribute set to “PENDING”. The AMF #2 may initiate the slice-specific authentication and authorization for S-NSSAIs in “PENDING” status at next UE uplink activity.

At procedures 6-11, EAP-messages are exchanged with the UE via AMF #1. One or more than one iterations of these procedures may occur. Then, at procedure 12, EAP authentication completes. An EAP-Success/Failure message is delivered to the NSSAAF/AAA-P along with GPSI and S-NSSALENSI. At procedure 13, the NSSAAF sends the Nnssaaf_NSSAA_Authenticate Response (EAP-Success/Failure, S-NSSAI, GPSI) to the AMF #1. At procedure 14, the AMF #1 transmits a NAS MM Transport message (EAP-Success/Failure) to the UE. At procedure 15, based on the result of Slice specific authentication (EAP-Success/Failure), if a new Allowed NSSAI or new Rejected NSSAIs needs to be delivered to the UE, or if the AMF #1 re-allocation is required, the AMF #1 initiates the UE Configuration Update procedure, for each Access Type.

If AMF #2 re-triggers NSSAA procedure and sends EAP ID request to the UE after procedure 15, the UE may responds with EAP ID as there's no ongoing NSSAA in parallel. Then another NSSAA procedure will start as usual.

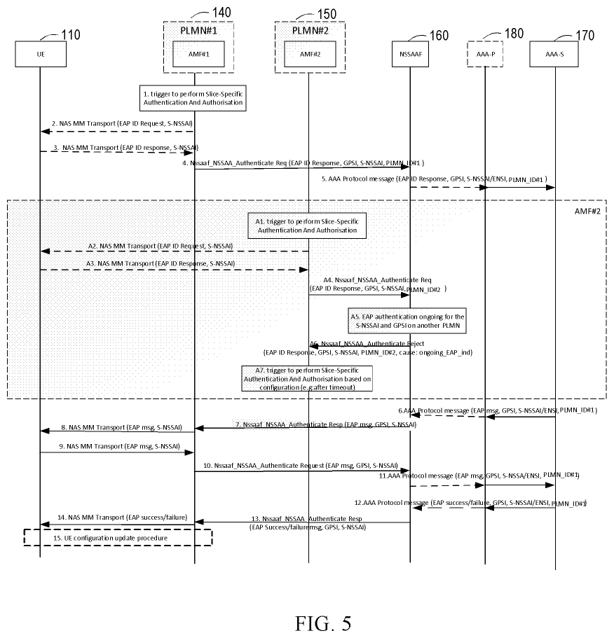

FIG. 5 illustrates an example signaling chart showing an example process of single NSSAA session controlled by NSSAAF, in accordance with some embodiments of the present disclosure. For the purpose of discussion, the process will be described with reference to FIG. 1A. The process may involve the UE 110, the AMF #1 140, the AMF #2 150, the NSSAAF 160, the AAA-P 180 and the AAA-S 170. In this case, if the UE is registering in two PLMNs, the NSSAA towards the UE will be initiated by the AMFs in the respective PLMNs, (because the AMFs in the respective PLMNs are not coordinated). The NSSAA authentication Request towards the AAA-S will be received at the NSSAAF in HPLMN.

When the EAP ID response with same GPSI+S-NSSAI from AMF #2 of second PLMN is received at the NSSAF, the NSSAAF drops the message or return error to AMF #2 to indicate there's ongoing NSSAA for the same GPSI+S-NSSAI combination. AMF #2 of the second PLMN may try to initiate the NSSAA again later, by sending the authentication request to NSSAAF several times based on configuration/policies. The message from NSSAAF to AMF #2, to indicate 1) An authentication for (EAP-ID, GPSI, S-NSSAI) is ongoing, 2) Authentication for (EAP-ID, GPSI, S-NSSAI) has been completed, are possible new services/messages to be defined.

As shown in FIG. 5, the following procedures may be performed. 1. For S-NSSAIs that are requiring NSSAA, based on change of subscription information, or triggered by the AAA-S, the AMF #1 may trigger the start of the NSSAA procedure. 2. The AMF #1 may request the UE User ID for EAP authentication (EAP ID) for the S-NSSAI in a NAS MM Transport message including the S-NSSAI. 3. The UE provides the EAP ID for the S-NSSAI alongside the S-NSSAI in an NAS MM Transport message towards the AMF #1. 4. The AMF #1 sends the EAP ID to the NSSAAF which provides interface with the AAA, in an Nnssaaf_NSSAA_Authenticate Request (EAP ID Response, GPSI, S-NSSAI). 5. The NSSAAF forwards the EAP ID Response message to the NSSAAF forwards the message directly/indirectly to the AAA-S 170. The AAA-S 170 uses the EAP-ID and S-NSSAI to identify for which UE and slice authorisation is requested.

At A1, the AMF #2 decides to trigger the slice specific Authentication and authorization towards the UE. At A2, the AMF #2 may request the UE User ID for EAP authentication (EAP ID) for the S-NSSAI in a NAS MM Transport message including the S-NSSAI. At A3, the UE provides the EAP ID response for the S-NSSAI alongside the S-NSSAI in an NAS MM Transport message towards the AMF #2. At A4, the AMF #2 forwards the message with EAP ID response, GPSI, S-NSSAI with PLMN_ID #2 to NSSAAF.

Then, at A5, The NSSAAF recognizes with GPSI and S-NSSAI that there is already an ongoing NSSAA authentication for another PLMN. At A6, the NSSAAF silently drop the message or responds with Nssaaf_NSSAA_Authenticate_Reject message with failure cause as “ongoing_EAP_IND” towards AMF #2. At A7, the AMF #2 starts the timer based on the operator configuration and after the time out the AMF #2 re-triggers the Slice specific authentication and authorization. If the retry attempts are exhausted, the AMF stops the slice-specific authentication and authorization procedure. If the AMF #2 stops the slice-specific authentication and authorization procedure (i.e. after exhausting the retry attempts or when the UE becomes unreachable), the AMF shall keep the “status” attribute set to “PENDING”. The AMF #2 may initiate the slice-specific authentication and authorization for S-NSSAIs in “PENDING” status at next UE uplink activity.

At procedures 6-11, EAP-messages are exchanged with the UE via AMF #1. One or more than one iterations of these steps may occur. At procedure 12, EAP authentication completes. An EAP-Success/Failure message is delivered to the NSSAAF/AAA-P along with GPSI, PLMN_ID #1 and S-NSSAI/ENSI. At procedure 13, the NSSAAF sends the Nnssaaf_NSSAA_Authenticate Response (EAP-Success/Failure, S-NSSAI, GPSI) to the AMF #1. At procedure 14, the AMF #1 transmits a NAS MM Transport message (EAP-Success/Failure) to the UE. At procedure 15, based on the result of Slice specific authentication (EAP-Success/Failure), if a new Allowed NSSAI or new Rejected NSSAIs needs to be delivered to the UE, or if the AMF #1 re-allocation is required, the AMF #1 initiates the UE Configuration Update procedure, for each Access Type.

If AMF #2 re-triggers NSSAA procedure after procedure 15, the NSSAAF may continue the new NSSAA procedure when received Nnssaaf_NSSAA_Authenticate Request from the AMF #2.

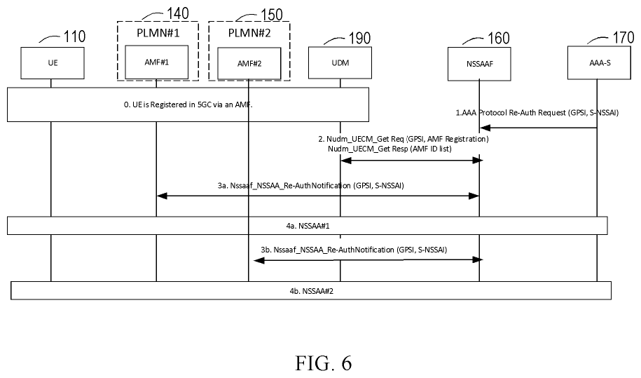

FIG. 6 illustrates an example signaling chart showing an example process of single NSSAA session controlled by NSSAAF for re-authentication, in accordance with some embodiments of the present disclosure. For the purpose of discussion, the process will be described with reference to FIG. 1A. The process may involve the UE 110, the AMF #1 140, the AMF #2 150, the UDM 190, the NSSAAF 160, and the AAA-S 170. In this case, re-authentication and re-authorization request from AAA-S is received, and NSSAAF gets the AMF IDs from UDM using Nudm_UECM_Get with the GPSI in the received AAA message. If NSSAAF receives two different AMF address from the UDM, then the NSSAAF should serialize the re-authentication, i.e. notify one AMF first and notify the other AMF only after the first NSSAA procedure completed.

As shown in FIG. 6, the following procedures may be performed. At procedures 1-2, after received re-authentication request from NSSAAF for an S-NSSAI of a UE, the NSSAAF gets AMFs from UDM. At procedures 3a-4a, the NSSAAF sends notification to one AMF to trigger re-authentication. Then, at procedures 3b-4b, after completed the re-authentication triggered by the first AMF, the NSSAAF may send notification to another AMF to trigger re-authentication.

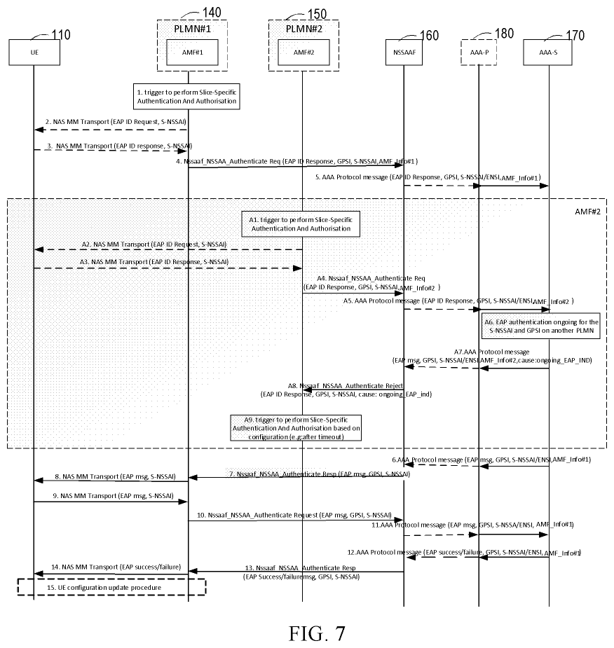

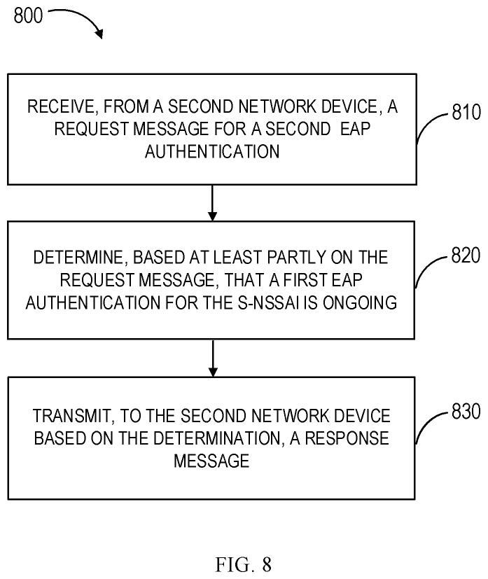

FIG. 7 illustrates an example signaling chart showing an example process of single NSSAA session controlled by AAA-S, in accordance with some embodiments of the present disclosure. For the purpose of discussion, the process will be described with reference to FIG. 1A. The process may involve the UE 110, the AMF #1 140, the AMF #2 150, the NSSAAF 160, the AAA-P 180 and the AAA-S 170. In this case, if the EAP ID response with same GPSI+S-NSSAI from NSSAAF is received for the authentication, AAA-S checks EAP ID in the response. If it's the same ID as the ongoing authentication session, AAA-S may send error back to NSSAAF. If it's timed out, NSSAAF will send a timeout error to the AMF #2, if NSSAAF is still maintaining the session. Otherwise, AMF/PLMN ID is needed to identify AMF #2.

As shown in FIG. 7, the following procedures may be performed. 1. For S-NSSAIs that are requiring NSSAA, based on change of subscription information, or triggered by the AAA-S, the AMF #1 may trigger the start of the NSSAA procedure. 2. The AMF #1 may request the UE User ID for EAP authentication (EAP ID) for the S-NSSAI in a NAS MM Transport message including the S-NSSAI. 3. The UE provides the EAP ID for the S-NSSAI alongside the S-NSSAI in an NAS MM Transport message towards the AMF #1. 4. The AMF #1 sends the EAP ID to the NSSAAF which provides interface with the AAA, in an Nnssaaf_NSSAA_Authenticate Request (EAP ID Response, GPSI, S-NSSAI, AMF_Info #1). 5. The NSSAAF forwards the EAP ID Response message directly/indirectly to the AAA-S. The AAA-S uses the EAP-ID and S-NSSAI to identify for which UE and slice authorization is requested.

At A1, the AMF #2 decides to trigger the slice specific Authentication and authorization towards the UE. At A2, the AMF #2 may request the UE User ID for EAP authentication (EAP ID) for the S-NSSAI in a NAS MM Transport message including the S-NSSAI. At A3, the UE provides the EAP ID for the S-NSSAI alongside the S-NSSAI in an NAS MM Transport message towards the AMF #2. At A4, the AMF #2 forwards the message with EAP ID response, GPSI, S-NSSAI with AMF_Info #2 to NSSAF. At A5, the NSSAAF forwards the AAA protocol message to AAA-S.

Then, at A6, the AAA-S recognizes with GPSI, AMF_Info #2 and S-NSSAI that there is already an ongoing NSSAA authentication for another PLMN. At A7, the AAA-S responds with failure cause as “ongoing_EAP_IND” towards NSSAAF with AMF_Info. At A8, the NSSAAF forward the Nssaaf_NSSAA_Authenticate_Reject message with failure cause as “ongoing_EAP_IND” towards AMF #2 based on AMF_Info. At A9, AMF #2 starts the timer based on the operator configuration and after the time out the AMF #2 re-triggers the Slice specific authentication and authorization.

After that, at procedures 6-11, EAP-messages are exchanged with the UE via AMF #1. One or more than one iterations of these steps may occur. At procedure 12, EAP authentication completes. An EAP-Success/Failure message is delivered to the NSSAAF/AAA-P along with GPSI and S-NSSALENSI. At procedure 13, the NSSAAF sends the Nnssaaf_NSSAA_Authenticate Response (EAP-Success/Failure, S-NSSAI, and GPSI) to the AMF #1. At procedure 14, the AMF #1 transmits a NAS MM Transport message (EAP-Success/Failure) to the UE. At procedure 15, based on the result of Slice specific authentication (EAP-Success/Failure), if a new Allowed NSSAI or new Rejected NSSAIs needs to be delivered to the UE, or if the AMF #1 re-allocation is required, the AMF #1 initiates the UE Configuration Update procedure, for each Access Type.

If AMF #2 re-triggers NSSAA procedure after step 15, the AAA-S may continue the new NSSAA procedure when received AAA protocol message from the NSSAAF.

FIG. 8 illustrates a flowchart of an example method 800 implemented at a terminal device in accordance with some embodiments of the present disclosure. For the purpose of discussion, the method 800 will be described from the perspective of the terminal device 110 as shown in, e.g., FIGS. 1A, 2B and 4.

At block 810, the terminal device 110 receives, from a second network device (e.g., AMF #2 150), a request message for EAP ID for a second EAP authentication. The request message comprises an S-NSSAI. At block 820, the terminal device 110 determines, based at least partly on the request message, that a first EAP authentication for the S-NSSAI is ongoing. At block 830, the terminal device 110 transmits, to the second network device based on the determination, a response message. The second message comprises an indication indicating that the first EAP authentication is ongoing.

In some embodiments, to determine that the first EAP authentication for the S-NSSAI is ongoing, the terminal device 110 may monitor for a message indicating an EAP success for the first EAP authentication and determine that the message indicating the EAP success is not received.

In some embodiments, the first EAP authentication may be associated with a first network device (e.g., AMF #1 140). Moreover, the first network device may comprise a first AMF in a first PLMN and the second network device may comprise a second AMF in a second PLMN.

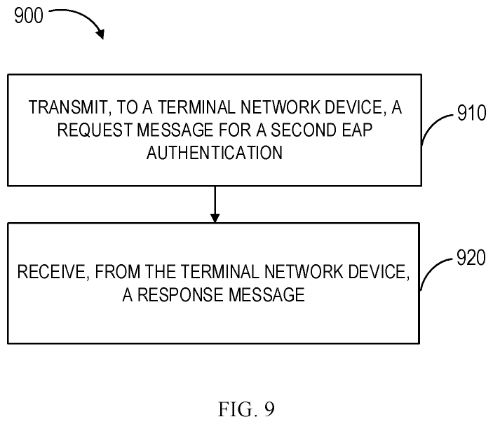

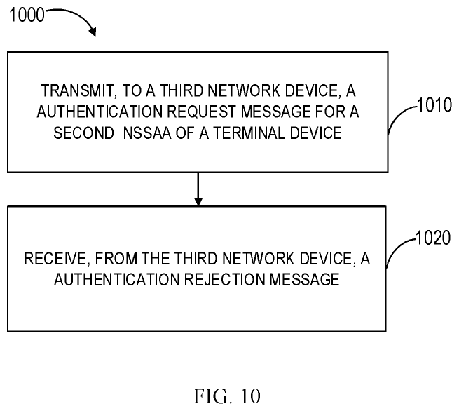

FIG. 9 illustrates a flowchart of an example method 900 implemented at a second network device in accordance with some embodiments of the present disclosure. For the purpose of discussion, the method 900 will be described from the perspective of the second network device (e.g., AMF #2) 150 as shown in, e.g., FIGS. 1A, 2B and 5.

At block 910, the second network device 150 transmits, to a terminal network device (e.g. UE 110), a request message for EAP ID for a second EAP authentication. The request message comprises a single S-NSSAI. At block 920, the second network device 150 receives, from the terminal network device, a response message. The response message comprises an indication indicating that a first EAP authentication for the S-NSSAI is ongoing.

In some embodiments, the second network device 150 may keep in a pending state based on that the first EAP authentication is ongoing. Moreover, the second network device 150 may initiate a further EAP authentication for the S-NSSAI at a next uplink activity of the terminal device.

In some embodiments, the first EAP authentication may be associated with a first network device (e.g., AMF #1 140). Moreover, the first network device may comprise a first AMF in a first PLMN and the second network device may comprise a second AMF in a second PLMN.

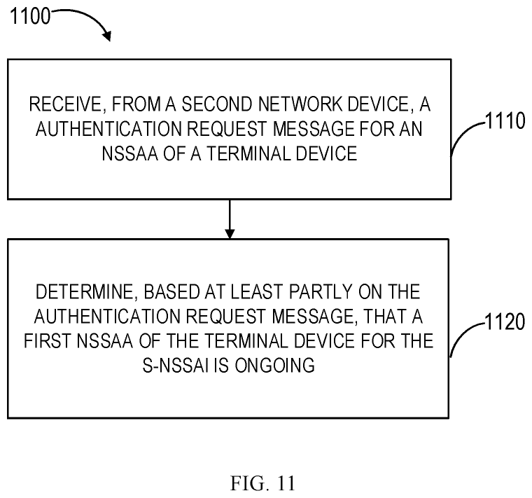

FIG. 10 illustrates a flowchart of another example method 1000 implemented at a second network device in accordance with some embodiments of the present disclosure. For the purpose of discussion, the method 1000 will be described from the perspective of the second network device (e.g., AMF #2) 150 as shown in, e.g., FIGS. 1A, 2C, 2D and 6-8.

At block 1010, the second network device 150 transmits, to a third network device (e.g., the NSSAAF 160), an authentication request message for a second NSSAA of a terminal device (e.g., UE 110). The authentication request message comprises at least an S-NSSAI and a GPSI. At block 1020, the second network device 150 receives, from the third network device, an authentication rejection message. The first authentication rejection message comprises at least the S-NSSAI and an indication indicating that a first NSSAA for the S-NSSAI is ongoing.

In some embodiments, each of the authentication request message and the authentication rejection message may further comprise an EAP ID response from the terminal device. The EAP ID response may be for an EAP authentication for the S-NSSAI. Alternatively or in addition, each of the authentication request message and the authentication rejection message may further comprise AMF information of the second network device.

In some embodiments, the first EAP authentication may be associated with a first network device (e.g., AMF #1 140). Moreover, the first network device may comprise a first AMF in a first PLMN and the second network device may comprise a second AMF in a second PLMN. The third network device may comprise an NSSAAF.

FIG. 11 illustrates a flowchart of an example method 1100 implemented at a third network device in accordance with some embodiments of the present disclosure. For the purpose of discussion, the method 1100 will be described from the perspective of the third network device (e.g., NSSAAF) 160 as shown in, e.g., FIGS. 1A, 2C and 6-7.

At block 1110, the third network device 160 receives, from a second network device (e.g., the AMF #2 150), an authentication request message for a second NSSAA of a terminal device (e.g., UE 110). The authentication request message comprises at least an S-NSSAI and a GPSI. At block 1120, the third network device 160 determines, based at least partly on the authentication request message, that a first NSSAA of the terminal device for the S-NSSAI is ongoing. The first NSSAA is associated with a first network device (e.g., the AMF #1 140).

In some embodiments, the third network device 160 may drop the authentication request message. Alternatively, the third network device 160 may transmit, to the second network device based on the determination, an authentication rejection message. The authentication rejection message may comprise at least the S-NSSAI, the GPSI, and an indication indicating that the first NSSAA is ongoing.

In some embodiments, each of the authentication request message and the authentication rejection message may further comprise an EAP ID response from the terminal device. The EAP ID response may be for an EAP authentication for the S-NSSAI. In some embodiments, the third network device 160 may receive, from a fourth network device, a re-authentication request message for an S-NSSAI of the terminal device. The third network device 160 may transmit, to one of the first network device and the second network device, a first notification to trigger a first re-authentication of the terminal device. Based on a determination that the first re-authentication has been completed, the third network device 160 may transmit, to other one of the first network device and the second network device, a second notification to trigger a second re-authentication of the terminal device.

In some embodiments, the first network device may comprise a first AMF in a first PLMN. The second network device may comprise a second AMF in a second PLMN. The third network device may comprise an NSSAAF. The fourth network device may comprise an AAA-S or an AAA-P.

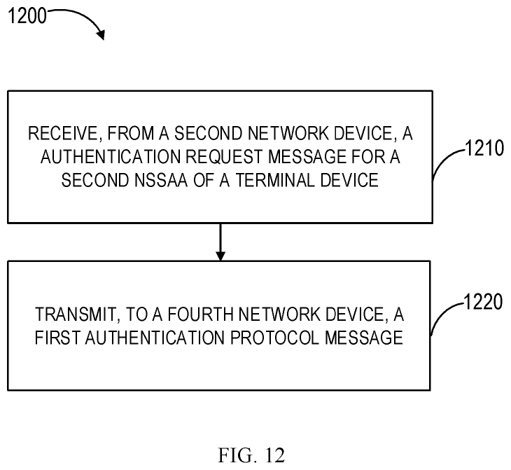

FIG. 12 illustrates a flowchart of another example method 1200 implemented at a third network device in accordance with some embodiments of the present disclosure. For the purpose of discussion, the method 1200 will be described from the perspective of the third network device (e.g., NSSAAF) 160 as shown in, e.g., FIGS. 1A, 2D and 8.

At block 1210, the third network device 160 receives, from a second network device (e.g., the AMF #2 150), an authentication request message for a second NSSAA of a terminal device (e.g., UE 110). The authentication request message comprising at least a single S-NSSAI, first AMF information of the second network device, and a GPSI. At block 1220, the third network device 160 transmits, to a fourth network device, a first authentication protocol message. The first authentication protocol message comprises at least the S-NSSAI, the first AMF information, and the GPSI.

In some embodiments, each of the authentication request message and the first authentication protocol message may further comprise an EAP ID response from the terminal device. The EAP ID response may be for a second EAP authentication for the S-NSSAI.

In some embodiments, the third network device 160 may receive, from the fourth network device, a second authentication protocol message. The second authentication protocol message may comprise at least the S-NSSAI, the GPSI, and an indication indicating that a first EAP authentication for the S-NSSAI is ongoing. In some embodiments, the third network device 160 may transmit, to the second network device, an authentication rejection message. The authentication rejection message may comprise at least the S-NSSAI, the GPSI and the indication.

In some embodiments, the first NSSAA and the first EAP authentication may be associated with a first network device. The first network device may comprise a first AMF in a first PLMN. The second network device may comprise a second AMF in a second PLMN. The third network device may comprise an NSSAAF. The fourth network device may comprise an AAA-S or an AAA-P.

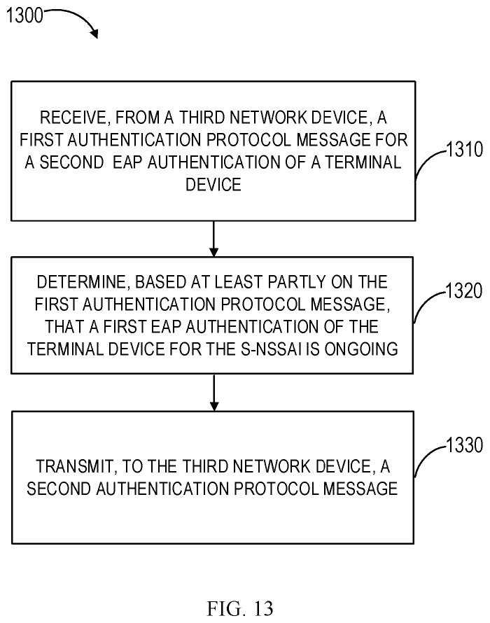

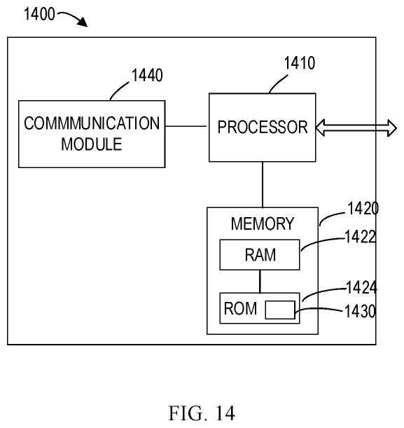

FIG. 13 illustrates a flowchart of an example method 1300 implemented at a fourth network device in accordance with some embodiments of the present disclosure. For the purpose of discussion, the method 1300 will be described from the perspective of the fourth network device (e.g., AAA-S) 170 as shown in, e.g., FIGS. 1A, 2D and 8.

At block 1310, the fourth network device 170 receives, from a third network device (e.g., NSSAAF 160), a first authentication protocol message for a second EAP authentication of a terminal device (e.g., UE 110). The first authentication protocol message comprises at least an S-NSSAI, a first AMF information of a second network device (e.g., AMF #2 150), and a GPSI.

At block 1320, the fourth network device 170 determine, based at least partly on the first authentication protocol message, that a first EAP authentication of the terminal device for the S-NSSAI is ongoing. At block 1330, the fourth network device 170 transmits, to the third network device, a second authentication protocol message. The second authentication protocol message comprises at least the S-NSSAI, the first AMF information, the GPSI, and an indication indicating the first EAP authentication is ongoing.

In some embodiments, the first EAP authentication may be associated with a first network device. The second EAP authentication may be associated with a second network device. The first network device may comprise a first AMF in a first PLMN. The second network device may comprise a second AMF in a second PLMN. The third network device may comprise an NSSAAF. The fourth network device may comprise an AAA-S.

In some embodiments, an apparatus capable of performing any of the method 800 (for example, the terminal device 110) may comprise means for performing the respective steps of the method 800. The means may be implemented in any suitable form. For example, the means may be implemented in a circuitry or software module.

In some embodiments, the apparatus comprises means for: receiving, from a second network device, a request message for extensible authentication protocol identity, EAP ID, for a second EAP authentication, the request message comprising a single network slice selection assistance information, S-NSSAI; determining, based at least partly on the request message, that a first EAP authentication for the S-NSSAI is ongoing; and transmitting, to the second network device based on the determination, a response message, the second message comprising an indication indicating that the first EAP authentication is ongoing.

In some embodiments, the means for determining that the first EAP authentication for the S-NSSAI is ongoing comprises means for: monitoring for a message indicating an EAP success for the first EAP authentication; and determining that the message indicating the EAP success is not received. In some embodiments, the first EAP authentication is associated with a first network device, the first network device comprises a first access and mobility management function, AMF, in a first public land mobile network, PLMN, and the second network device comprises a second AMF in a second PLMN.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

In some embodiments, an apparatus capable of performing any of the method 900 (for example, the second network device 150) may comprise means for performing the respective steps of the method 900. The means may be implemented in any suitable form. For example, the means may be implemented in a circuitry or software module.

In some embodiments, the apparatus comprises means for: transmitting, to a terminal network device, a request message for extensible authentication protocol, EAP identity, for a second EAP authentication, the request message comprising a single network slice selection assistance information, S-NSSAI; and receiving, from the terminal network device, a response message, the response message comprising an indication indicating that a first EAP authentication for the S-NSSAI is ongoing.

In some embodiments, the apparatus further comprises means for: keep in a pending state based on that the first EAP authentication is ongoing; and initiate a further EAP authentication for the S-NSSAI at a next uplink activity of the terminal device. In some embodiments, the first EAP authentication is associated with a first network device, the first network device comprises a first access and mobility management function, AMF, in a first public land mobile network, PLMN, and the second network device comprises a second AMF in a second PLMN.

In some embodiments, the apparatus further comprises means for performing other steps in some embodiments of the method 900. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1000 (for example, the second network device 150) may comprise means for performing the respective steps of the method 1000. The means may be implemented in any suitable form. For example, the means may be implemented in a circuitry or software module.

In some embodiments, the apparatus comprises means for: transmitting, to a third network device, an authentication request message for a second network slice specific authentication and authorization, NSSAA, of a terminal device, the authentication request message comprising at least a single network slice selection assistance information, S-NSSAI, and a generic public subscription identifier, GPSI; and receiving, from the third network device, an authentication rejection message, the first authentication rejection message comprising at least the S-NSSAI and an indication indicating that a first NSSAA for the S-NSSAI is ongoing.

In some embodiments, each of the authentication request message and the authentication rejection message further comprises at least one of: an extensible authentication protocol identity, EAP ID, response from the terminal device, wherein the EAP ID response is for an EAP authentication for the S-NSSAI; or access and mobility management function, AMF, information of the second network device. In some embodiments, the first NSSAA is associated with a first network device, the first network device comprises a first access and mobility management function, AMF, in a first public land mobile network, PLMN, the second network device comprises a second AMF in a second PLMN, and the third network device comprises a network slice specific authentication and authorization function, NSSAAF.

In some embodiments, the apparatus further comprises means for performing other steps in some embodiments of the method 1000. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1100 (for example, the third network device 160) may comprise means for performing the respective steps of the method 1100. The means may be implemented in any suitable form. For example, the means may be implemented in a circuitry or software module.

In some embodiments, the apparatus comprises means for: receiving, from a second network device, an authentication request message for a second network slice specific authentication and authorization, NSSAA, of a terminal device, the authentication request message comprising at least a single network slice selection assistance information, S-NSSAI, and a generic public subscription identifier, GPSI; and determining, based at least partly on the authentication request message, that a first NSSAA of the terminal device for the S-NSSAI is ongoing, the first NSSAA being associated with a first network device.

In some embodiments, the apparatus further comprises means for: dropping the authentication request message; or transmitting, to the second network device based on the determination, an authentication rejection message, the authentication rejection message comprising at least the S-NSSAI, the GPSI, and an indication indicating that the first NSSAA is ongoing. In some embodiments, each of the authentication request message and the authentication rejection message further comprises: an extensible authentication protocol identity, EAP ID, response from the terminal device, wherein the EAP ID response is for an EAP authentication for the S-NSSAI.

In some embodiments, the apparatus further comprises means for: receiving, from a fourth network device, a re-authentication request message for a S-NSSAI of the terminal device; transmit, to one of the first network device and the second network device, a first notification to trigger a first re-authentication of the terminal device; and based on a determination that the first re-authentication has been completed, transmitting, to other one of the first network device and the second network device, a second notification to trigger a second re-authentication of the terminal device.

In some embodiments, the first network device comprises a first access and mobility management function, AMF, in a first PLMN, the second network device comprises a second AMF in a second PLMN, the third network device comprises a network slice specific authentication and authorization function, NSSAAF, and the fourth network device comprises an authentication, authorization, and accounting server, AAA-S or an AAA proxy, AAA-P.

In some embodiments, the apparatus further comprises means for performing other steps in some embodiments of the method 1100. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1200 (for example, the third network device 160) may comprise means for performing the respective steps of the method 1200. The means may be implemented in any suitable form. For example, the means may be implemented in a circuitry or software module.

In some embodiments, the apparatus comprises means for: receiving, from a second network device, an authentication request message for a second network slice specific authentication and authorization, NSSAA of a terminal device, the authentication request message comprising at least a single network slice selection assistance information, S-NSSAI, a first access and mobility management function, AMF, information of the second network device, and a generic public subscription identifier, GPSI; and transmitting, to a fourth network device, a first authentication protocol message, the first authentication protocol message comprising at least the S-NSSAI, the first AMF information, and the GPSI.

In some embodiments, each of the authentication request message and the first authentication protocol message further comprises an extensible authentication protocol identity, EAP ID, response from the terminal device, and wherein the EAP ID response is for a second EAP authentication for the S-NSSAI.

In some embodiments, the apparatus further comprises means for receiving, from the fourth network device, a second authentication protocol message, the second authentication protocol message comprising at least the S-NSSAI, the GPSI, and an indication indicating that a first EAP authentication for the S-NSSAI is ongoing. In some embodiments, the apparatus further comprises means for transmitting, to the second network device, an authentication rejection message, the authentication rejection message comprising at least the S-NSSAI, the GPSI and the indication.

In some embodiments, the first NSSAA and the first EAP authentication are associated with a first network device, the first network device comprises a first access and mobility management function, AMF, in a first PLMN, the second network device comprises a second AMF in a second PLMN, the third network device comprises a network slice specific authentication and authorization function, NSSAAF, and the fourth network device comprises an authentication, authorization, and accounting server, AAA-S or an AAA proxy, AAA-P.

In some embodiments, the apparatus further comprises means for performing other steps in some embodiments of the method 1200. In some embodiments, the means comprises at least one processor; and at least one memory including computer program code, the at least one memory and computer program code configured to, with the at least one processor, cause the performance of the apparatus.

In some embodiments, an apparatus capable of performing any of the method 1300 (for example, the fourth network device 170) may comprise means for performing the respective steps of the method 1300. The means may be implemented in any suitable form. For example, the means may be implemented in a circuitry or software module.

In some embodiments, the apparatus comprises means for: receiving, from a third network device, a first authentication protocol message for a second extensible authentication protocol, EAP, authentication of a terminal device, the first authentication protocol message comprising at least a single network slice selection assistance information, S-NSSAI, a first access and mobility management function, AMF, information of a second network device, and a generic public subscription identifier, GPSI; determining, based at least partly on the first authentication protocol message, that a first EAP authentication of the terminal device for the S-NSSAI is ongoing; and transmitting, to the third network device, a second authentication protocol message, the second authentication protocol message comprising at least the S-NSSAI, the first AMF information, the GPSI, and an indication indicating the first EAP authentication is ongoing.

In some embodiments, the first EAP authentication is associated with a first network device, the second EAP authentication is associated with a second network device, the first network device comprises a first access and mobility management function, AMF, in a first PLMN, the second network device comprises a second AMF in a second PLMN, the third network device comprises a network slice specific authentication and authorization function, NSSAAF, and the fourth network device comprises an authentication, authorization, and accounting server, AAA-S.

In some embodiments, the apparatus further comprises means for performing other steps in some embodiments of the method 1300. In some embodiments, the means comprises at least one processor; and at least one memory including computer program code, the at least one memory and computer program code configured to, with the at least one processor, cause the performance of the apparatus.

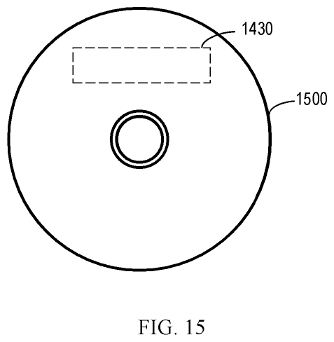

FIG. 14 is a simplified block diagram of a device 1400 that is suitable for implementing embodiments of the present disclosure. The device 1400 may be provided to implement the communication device, for example the terminal device 110, the first access point 120, the second access point 130, the first network 140, the second network 140, the third network device 160, the fourth network device 170, the AAA-P 180 and the UDM 190 as shown in FIG. 1A. As shown, the device 1400 includes one or more processors 1410, one or more memories 1440 coupled to the processor 1410, and one or more communication modules (TX/RX) 1440 coupled to the processor 1410.

The TX/RX 1440 is for bidirectional communications. The TX/RX 1440 has at least one antenna to facilitate communication. The communication interface may represent any interface that is necessary for communication with other network elements.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1422 and other volatile memories that will not last in the power-down duration.

A computer program 1430 includes computer executable instructions that are executed by the associated processor 1410. The program 1430 may be stored in the ROM 1420. The processor 1410 may perform any suitable actions and processing by loading the program 1430 into the RAM 1420.

The embodiments of the present disclosure may be implemented by means of the program 1430 so that the device 1400 may perform any process of the disclosure as discussed with reference to FIGS. 2 to 13. The embodiments of the present disclosure may also be implemented by hardware or by a combination of software and hardware.

In some embodiments, the program 1430 may be tangibly contained in a computer readable medium which may be included in the device 1400 (such as in the memory 1420) or other storage devices that are accessible by the device 1400. The device 1400 may load the program 1430 from the computer readable medium to the RAM 1422 for execution. The computer readable medium may include any types of tangible non-volatile storage, such as ROM, EPROM, a flash memory, a hard disk, CD, DVD, and the like. FIG. 15 shows an example of the computer readable medium 1500 in form of CD or DVD. The computer readable medium has the program 1430 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a transitory or non-transitory computer readable storage medium. The computer program product includes computer-executable instructions, such as those included in program modules, being executed in a device on a target real or virtual processor, to carry out the methods 800-1400 as described above with reference to FIGS. 8 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. This program code may be provided to a processor or controller of a general purpose computer, special purpose computer, or other programmable data processing device, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the instructions or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementting the claims.

1-39. (canceled)

40. A terminal device comprising:
at least one processor; and
at least one memory storing instructions that, when executed by the at least one processor, cause the terminal device at least to:
initiate a first registration procedure with a first network device of a first public land mobile network, PLMN; and
based on determining that the first registration procedure is completed, initiate a second registration procedure with a second network device of a second PLMN.

41. The terminal device of claim 40, wherein the terminal device is further caused to:
determine, based on a registration accept message of the first registration procedure from the first network device, a first pending set of Network Slice Selection Assistance Information, NSSAI, associated with the first registration procedure; and
map the first pending set of NSSAI to a second pending set of NSSAI associated with the second registration procedure.

42. The terminal device of claim 41, wherein the terminal device is further caused to:
exclude a set of Single Slice Selection Assistance Information, S-NSSAI, of the second pending set of NSSAI from a requested set of NSSAI associated with the second registration procedure.

43. A terminal device comprising:
at least one processor; and
at least one memory storing instructions that, when executed by the at least one processor, cause the terminal device at least to:
receive, from a second network device, a request message for extensible authentication protocol identify, EAP ID, for a second EAP authentication, the request message comprising a single network slice selection assistance information, S-NSSAI;
determine, based at least partly on the request message, that a first EAP authentication for the S-NSSAI is ongoing; and
transmit, to the second network device based on the determination, a response message, the response message comprising an indication indicating that the first EAP authentication is ongoing.

44. The terminal device of claim 43, wherein the terminal device is caused to determine that the first EAP authentication for the S-NSSAI is ongoing by:
monitoring for a message indicating an EAP success for the first EAP authentication; and
determining that the message indicating the EAP success is not received.

45. The terminal device of claim 43, wherein:
the first EAP authentication is associated with a first network device,
the first network device comprises a first access and mobility management function, AMF,
in a first public land mobile network, PLMN, and
the second network device comprises a second AMF in a second PLMN.

46. A second network device comprising:
at least one processor; and
at least one memory storing instructions that, when executed by the at least one processor, cause the second network device at least to:
transmit, to a terminal network device, a request message for extensible authentication protocol identity, EAP ID, for a second EAP authentication, the request message comprising a single network slice selection assistance information, S-NSSAI; and
receive, from the terminal network device, a response message, the response message comprising an indication indicating that a first EAP authentication for the S-NSSAI is ongoing.

47. The second network device of claim 46, wherein the second network device is further caused to:
keep in a pending state based on that the first EAP authentication is ongoing; and
initiate a further EAP authentication for the S-NSSAI at a next uplink activity of the terminal device.

48. The second network device of claim 46, wherein:
the first EAP authentication is associated with a first network device,
the first network device comprises a first access and mobility management function, AMF,
in a first public land mobile network, PLMN, and
the second network device comprises a second AMF in a second PLMN.

49. A second network device comprising:
at least one processor; and
at least one memory storing instructions that, when executed by the at least one processor, cause the second network device at least to:
transmit, to a third network device, an authentication request message for a second network slice specific authentication and authorization, NSSAA, of a terminal device, the authentication request message comprising at least a single network slice selection assistance information, S-NSSAI, and a generic public subscription identifier, GPSI; and
receive, from the third network device, an authentication rejection message, the first authentication rejection message comprising at least the S-NSSAI and an indication indicating that a first NSSAA for the S-NSSAI is ongoing.

50. The second network device of claim 49, wherein each of the authentication request message and the authentication rejection message further comprises at least one of:
an extensible authentication protocol identity, EAP ID, response from the terminal device, wherein the EAP ID response is for an EAP authentication for the S-NSSAI; or
access and mobility management function, AMF, information of the second network device.

51. The second network device of claim 49, wherein:
the first NSSAA is associated with a first network device,
the first network device comprises a first access and mobility management function, AMF, in a first public land mobile network, PLMN,
the second network device comprises a second AMF in a second PLMN, and
the third network device comprises a network slice specific authentication and authorization function, NSSAAF.
